(19) United States
(12) Patent Application Publication
(10) Pub. No.: US 2014/0209595 A1
(43) Pub. Date: Jul. 31, 2014

(54) PRESSURE-SENSITIVE ADHESIVE FORCE EXPRESSING UNIT, PRESSURE-SENSITIVE ADHESIVE LABEL ISSUING DEVICE, PRINTER, PRESSURE-SENSITIVE ADHESIVE FORCE EXPRESSING METHOD, AND PRESSURE-SENSITIVE ADHESIVE FORCE EXPRESSING PROGRAM

(71) Applicant: Seiko Instruments Inc., Chiba-shi (JP)

(72) Inventors: Koichi HATAKEYAMA, Chiba-shi (JP); Yoshinori SATO, Chiba-shi (JP); Kazuo TANI, Chiba-shi (JP)

(73) Assignee: Seiko Instruments Inc., Chiba-shi (JP)

(21) Appl. No.: 14/166,143

(22) Filed: Jan. 28, 2014

(30) Foreign Application Priority Data
Jan. 29, 2013 (JP) 2013-014632

(51) Int. Cl. B65C 9/00; B65C 9/40; B65C 9/46

(52) U.S. Cl. CPC B65C 9/0015; B65C 9/46; B65C 9/40
USPC 219/385

(57) ABSTRACT

A pressure-sensitive adhesive force expressing unit including: a conveyance unit for conveying a pressure-sensitive adhesive label in a predetermined direction; a thermal head including a plurality of heat generating elements arranged along a direction substantially orthogonal to the predetermined direction, the thermal head being configured to heat the pressure-sensitive adhesive label from a pressure-sensitive adhesive layer side to form a bore in a non-pressure-sensitive-adhesive function layer and expose the pressure-sensitive adhesive layer; and a control unit for energizing the plurality of heat generating elements individually to control the plurality of heat generating elements to generate heat, the control unit being configured to control the plurality of heat generating elements to generate heat by providing an intermittent energization period of intermittently energizing the plurality of heat generating elements in a heat generating period of one cycle of forming bores for one row in the non-pressure-sensitive-adhesive function layer.

### RELATED APPLICATIONS

This application claims priority under 35 U.S.C. §119 to Japanese Patent Application No. 2013-014632 filed on Jan. 29, 2013, the entire content of which is hereby incorporated by reference.

### BACKGROUND OF THE INVENTION

1. Field of the Invention

The present invention relates to a pressure-sensitive adhesive force expressing unit, a pressure-sensitive adhesive label issuing device, a printer, a pressure-sensitive adhesive force expressing method, and a pressure-sensitive adhesive force expressing program.

2. Description of the Related Art

Hitherto, pressure-sensitive adhesive labels have been used for, for example, a POS label for foods, a logistics/transportation label, a medical label, a baggage tag, and an indication label for bottles and cans. A widely known example is a pressure-sensitive adhesive label that has a recording surface (printing surface) formed on a front surface of a base, a pressure-sensitive adhesive layer formed on a rear surface of the base, and release paper (separator) covering the pressure-sensitive adhesive layer.

When the pressure-sensitive adhesive label of this type is used, it is necessary to release the release paper from the pressure-sensitive adhesive layer after predetermined information such as a bar code or a price is printed on the recording surface. It is, however, actually difficult to recover and recycle the released release paper, and hence there is a problem in that the release paper becomes an industrial waste.

To address the problem, in recent years, a pressure-sensitive adhesive label that does not use release paper has come to be used from the viewpoint of environment protection and reduction in environmental burdens. For example, there has been proposed a pressure-sensitive adhesive label in which the entire surface of a pressure-sensitive adhesive layer is covered with a non-pressure-sensitive-adhesive resin layer, and the pressure-sensitive adhesive layer is exposed by forming bores (minute openings) in the resin layer by using a heat source such as a heated roll or a thermal head to express pressure-sensitive adhesive force (see, for example, Japanese Patent Application Laid-open No. 2012-145717).

By the way, there has been known a device configured to melt ink by using a thermal head to print on a printing medium (see, for example, Japanese Patent Application Laid-open No. 04-196188). In this device, a pulsed heat generating signal is periodically applied to heat generating elements so that the temperature of a heat generator may be constant around a melting temperature of ink.

The technology of exposing the pressure-sensitive adhesive layer to express pressure-sensitive adhesive force by forming the bores in the resin layer with the use of the heat source such as a thermal head has a problem in that a temperature difference is generated between a center part and an outer circumferential part of the heat generator so that the bores are unstably formed. Specifically, if heat generation is insufficient, the temperature of the heat generator is too low to melt the resin layer sufficiently at the outer peripheral part, and hence a bore having a desired size and shape cannot be formed. Further, in contrast, if larger energy is applied to the heat generator in order to sufficiently increase the temperature of the heat generator at the outer peripheral part, the resin layer is excessively melted to form an excessively large bore, or the melted resin layer agglutinates to generate undesirable unevenness on a pressure-sensitive adhesive surface.

In this regard, the above-mentioned related art (latter) is aimed at maintaining the temperature of the heat generator to be constant, and is therefore difficult to be applied directly to the device configured to expose the pressure-sensitive adhesive layer to express pressure-sensitive adhesive force by forming the bores in the resin layer with the use of the heat source such as a thermal head. As a result, it has been difficult for the related art to stably form a bore having a preferred shape.

### SUMMARY OF THE INVENTION

From the foregoing, in this technical field, demands have been made for a pressure-sensitive adhesive force expressing unit, a pressure-sensitive adhesive label issuing device, a printer, a pressure-sensitive adhesive force expressing method, and a pressure-sensitive adhesive force expressing program that are capable of stably forming a bore having a preferred shape.

The present invention provides the following measures in order to solve the above-mentioned problems.

According to one embodiment of the present invention, there is provided a pressure-sensitive adhesive force expressing unit that is configured to heat a pressure-sensitive adhesive label to express pressure-sensitive adhesive force thereof, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer, the pressure-sensitive adhesive force expressing unit including: a conveyance unit for conveying the pressure-sensitive adhesive label in a predetermined direction; a thermal head including a plurality of heat generating elements arranged along a direction substantially orthogonal to the predetermined direction, the thermal head being configured to heat the pressure-sensitive adhesive label from the pressure-sensitive adhesive layer side to form a bore in the non-pressure-sensitive-adhesive function layer and expose the pressure-sensitive adhesive layer; and a control unit for energizing the plurality of heat generating elements individually to control the plurality of heat generating elements to generate heat, the control unit being configured to control the plurality of heat generating elements to generate heat by providing an intermittent energization period of intermittently energizing the plurality of heat generating elements in a heat generating period of one cycle of forming bores for one row in the non-pressure-sensitive-adhesive function layer. According to one embodiment of the present invention, the bore having a preferred shape can be formed stably.

In one embodiment of the present invention, the control unit may provide, in the heat generating period of one cycle, after the intermittent energization period, a subsequent energization period in which a temperature reached by the plurality of heat generating elements is higher than in the intermittent energization period.

In one embodiment of the present invention, the control unit may energize the plurality of heat generating elements continuously in the subsequent energization period.

In one embodiment of the present invention, the control unit may maintain the plurality of heat generating elements at a temperature lower than a melting temperature of the non-pressure-sensitive-adhesive function layer in the intermittent energization period, and may guide the plurality of heat generating elements to have a temperature higher than the melting temperature of the non-pressure-sensitive-adhesive function layer in the subsequent energization period.

According to another embodiment of the present invention, there is provided a pressure-sensitive adhesive label issuing device including: the pressure-sensitive adhesive force expressing unit according to one embodiment of the present invention; and a cutter unit for cutting the pressure-sensitive adhesive label to a desired length.

According to another embodiment of the present invention, there is provided a printer including: the pressure-sensitive adhesive label issuing device according to another embodiment of the present invention; and a printing unit for printing on the printable layer, which is placed on an upstream side of the pressure-sensitive adhesive force expressing unit in the predetermined direction.

According to another embodiment of the present invention, there is provided a pressure-sensitive adhesive force expressing method for a computer for controlling a pressure-sensitive adhesive force expressing unit, the pressure-sensitive adhesive force expressing unit including: a conveyance unit for conveying a pressure-sensitive adhesive label in a predetermined direction, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer; and a thermal head including a plurality of heat generating elements arranged along a direction substantially orthogonal to the predetermined direction, the thermal head being configured to heat the pressure-sensitive adhesive label from the pressure-sensitive adhesive layer side to form a bore in the non-pressure-sensitive-adhesive function layer and expose the pressure-sensitive adhesive layer, the pressure-sensitive adhesive force expressing method including: setting, by the computer, an intermittent energization period of intermittently energizing the plurality of heat generating elements in a heat generating period of one cycle of forming bores for one row in the non-pressure-sensitive-adhesive function layer; and intermittently energizing, by the computer, the plurality of heat generating elements in the set intermittent energization period. According to this embodiment, the bore having a preferred shape can be formed stably.

According to another embodiment of the present invention, there is provided a pressure-sensitive adhesive force expressing program for causing a computer for controlling a pressure-sensitive adhesive force expressing unit, the pressure-sensitive adhesive force expressing unit including: a conveyance unit for conveying a pressure-sensitive adhesive label in a predetermined direction, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer; and a thermal head including a plurality of heat generating elements arranged along a direction substantially orthogonal to the predetermined direction, the thermal head being configured to heat the pressure-sensitive adhesive label from the pressure-sensitive adhesive layer side to form a bore in the non-pressure-sensitive-adhesive function layer and expose the pressure-sensitive adhesive layer, to perform processing of: setting an intermittent energization period of intermittently energizing the plurality of heat generating elements in a heat generating period of one cycle of forming bores for one row in the non-pressure-sensitive-adhesive function layer; and intermittently energizing the plurality of heat generating elements in the set intermittent energization period. According to this embodiment, the bore having a preferred shape can be formed stably.

According to one embodiment of the present invention, the pressure-sensitive adhesive force expressing unit, the pressure-sensitive adhesive label issuing device, the printer, the pressure-sensitive adhesive force expressing method, and the pressure-sensitive adhesive force expressing program that are capable of stably forming a bore having a preferred shape can be provided.

### BRIEF DESCRIPTION OF THE DRAWINGS

FIG. 1 is an exemplary configuration diagram illustrating a configuration of a thermal printer according to one embodiment of the present invention.

FIG. 2 is an exemplary cross-sectional view of a pressure-sensitive adhesive label.

FIG. 3 is an exemplary plan view of a thermal head when viewed from the pressure-sensitive adhesive label side.

FIG. 4 is an exemplary cross-sectional view taken along the line A-A of FIG. 3.

FIG. 5 is a diagram illustrating another example of a connection shape between a heat generating element and an electrode portion.

FIG. 6 is a diagram exemplifying a connection relationship between a plurality of heat generating elements and the electrode portion.

FIG. 7 is a diagram schematically illustrating how each heat generating unit generates heat in each cycle.

FIG. 8 is a diagram schematically illustrating how a plurality of bores having a shape close to a checkered pattern are formed in the pressure-sensitive adhesive label as a result of heat generation of each heat generating unit.

FIG. 9 is an exemplary configuration diagram mainly illustrating a control unit and an IC unit.

FIG. 10 is a graph exemplifying a relationship between an energization period of the heat generating element and a rise in temperature at a center part and an outer peripheral part of the heat generating element in a commonly used device.

FIGS. 11A and 11B are diagrams each illustrating an exemplary temperature distribution of the heat generating element.

FIGS. 12A to 12C are photographs showing results of forming the bores in the pressure-sensitive adhesive label while changing the energization time variously.

FIG. 13 is a graph exemplifying a relationship between the energization period of the heat generating element and the rise in temperature at the center part and the outer peripheral part of the heat generating element in the case where energization control of the heat generating element is performed by a CPU and the IC unit according to the embodiment of the present invention.

FIG. 14 is an exemplary uniformized temperature distribution of the heat generating element.

FIG. 15 is an explanatory diagram for describing the definition of periods to be set by the CPU.

FIG. 16 is an exemplary flowchart illustrating the flow of processing executed by the CPU.

### DETAILED DESCRIPTION OF THE PREFERRED EMBODIMENTS

Now referring to the accompanying drawings, a pressure-sensitive adhesive force expressing unit, a pressure-sensitive adhesive label issuing device, a printer, a pressure-sensitive adhesive force expressing method, and a pressure-sensitive adhesive force expressing program according to exemplary embodiments of the present invention are described below.

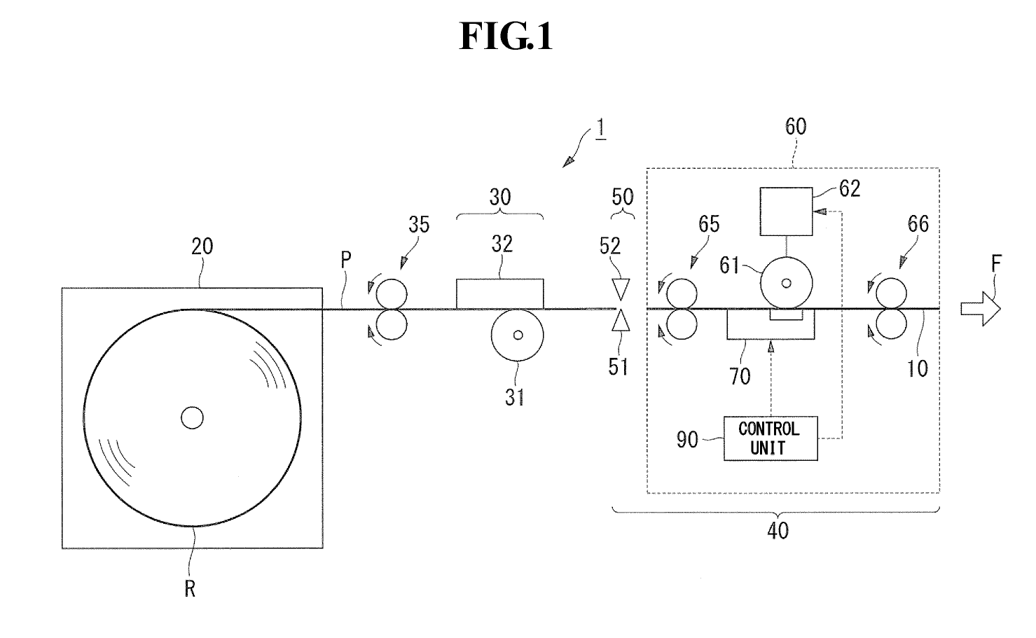

FIG. 1 is an exemplary configuration diagram illustrating a configuration of a thermal printer 1 (hereinafter referred to as “printer 1”) according to one embodiment of the present invention. The thermal printer 1 includes a printing unit 30 and a pressure-sensitive adhesive label issuing device 40. The pressure-sensitive adhesive label issuing device 40 includes a cutter unit 50 and a pressure-sensitive adhesive force expressing unit 60.

The printer 1 is a device configured to use roll paper R having a pressure-sensitive adhesive label 10 rolled therearound into a roll, print on a belt-shaped label sheet P unrolled from the roll paper R and thereafter cut the label sheet P to a predetermined length to obtain a pressure-sensitive adhesive label 10, and issue a label in a state in which the pressure-sensitive adhesive label 10 expresses pressure-sensitive adhesive force by the pressure-sensitive adhesive force expressing unit 60. Note that, in this embodiment described below, a conveyance direction of the label sheet P is represented by F, the roll paper R side is the upstream side, and the leading edge side in the conveyance direction F is the downstream side in the state illustrated in FIG. 1.

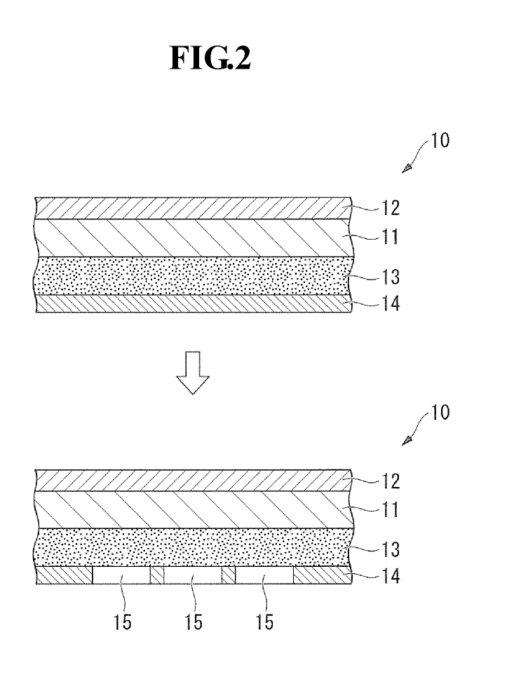

First, the pressure-sensitive adhesive label 10 is described. The roll paper R has the belt-shaped label sheet P rolled therearound, and is received and held rotatably in a roll paper receiving portion 20 placed on the upstream side of the printer 1. FIG. 2 is an exemplary cross-sectional view of the pressure-sensitive adhesive label 10. The label sheet P (pressure-sensitive adhesive label 10) includes a base 11, a printable layer 12 laminated on one surface of the base 11, a pressure-sensitive adhesive layer 13 laminated on another surface of the base 11, and a non-pressure-sensitive-adhesive function layer 14 that covers the surface of the pressure-sensitive adhesive layer 13. Note that, in the following description, the printable layer 12 side of the label sheet P is referred to as “front surface (one surface) side”, and the function layer 14 side thereof is referred to as “rear surface (another surface) side”.

The printable layer 12 is a thermosensitive recording layer that develops color by heating and is formed over the entire front surface of the base 11. The pressure-sensitive adhesive layer 13 is, for example, an acrylic pressure-sensitive adhesive having a thickness of about 10 μm to about 20 μm and is formed over the entire rear surface of the base 11. Note that, the pressure-sensitive adhesive is not limited to an acrylic pressure-sensitive adhesive and may be, for example, a rubber-based pressure-sensitive adhesive such as natural rubber, styrene butadiene rubber (SBR), or polyisobutylene rubber, or a silicon-based pressure-sensitive adhesive made of silicon having high cohesion and silicon resin having high pressure-sensitive adhesive force. The function layer 14 covers the entire surface of the pressure-sensitive adhesive layer 13. Specifically, the function layer 14 is, for example, a film made of PET, PP, or the like and having a thickness of about 1 μm, and is a bore forming layer in which bores 15 (see FIG. 2) are formed by heat melting. The bores 15 are formed by being heated locally by heat generating elements 73 of a thermal head 70 to be described later. Then, when the bores 15 are formed, the pressure-sensitive adhesive of the pressure-sensitive adhesive layer 13 is exposed on the rear surface of the pressure-sensitive adhesive label 10 through the bores 15, thereby expressing pressure-sensitive adhesive force. Note that, the melting temperature necessary when PP is used for the function layer 14, that is, the bore temperature at which the bores 15 are formed, is about 170° C., and the melting temperature necessary when PET is used is about 260° C.

Subsequently, the printer 1 is described. As illustrated in FIG. 1, the printer 1 includes the above-mentioned roll paper receiving portion 20 for receiving the roll paper R, the printing unit 30 for printing on the printable layer 12 of the label sheet P unrolled from the roll paper R, the cutter unit 50 for cutting the label sheet P printed by the printing unit 30 into the pressure-sensitive adhesive label 10 having a desired length, and the pressure-sensitive adhesive force expressing unit 60 for heating the pressure-sensitive adhesive label 10 cut by the cutter unit 50 so that the pressure-sensitive adhesive label 10 expresses pressure-sensitive adhesive force.

The printing unit 30 is a thermal printing mechanism including a printing platen roller 31 and a printing thermal head 32 that are arranged to be opposed in a thickness direction of the pressure-sensitive adhesive label 10 (vertical direction of FIG. 1), and is placed on the downstream side of the roll paper receiving portion 20.

The printing platen roller 31 is placed on the rear surface side of the label sheet P so as to be rotatable by a drive source (not shown). The printing unit 30 drives the drive source to rotate the printing platen roller 31 in a state in which the label sheet P is sandwiched between the printing platen roller 31 and the printing thermal head 32, thereby being capable of unrolling the label sheet P from the roll paper R to be conveyed.

The printing thermal head 32 is a line head in which a large number of heat generating elements are arranged along a width direction of the label sheet P, and is placed on the front surface side of the label sheet P. The printing thermal head 32 is pressed under pressure to the label sheet P side (printing platen roller 31 side) by an elastic member (not shown) such as a coil spring, and is brought into pressure contact with an outer peripheral surface of the printing platen roller 31.

Note that, first conveyance rollers 35 are placed between the roll paper receiving portion 20 and the printing unit 30, for delivering the label sheet P unrolled from the roll paper R toward the downstream side while sandwiching the label sheet P in the thickness direction.

The cutter unit 50 is a cutting mechanism including a fixed blade 51 and a movable blade 52, and is placed on the downstream side of the printing unit 30 in the conveyance direction F. The fixed blade 51 and the movable blade 52 are placed so that the blade edges may be opposed to each other across the label sheet P in the thickness direction. The fixed blade 51 is placed on the rear surface side of the label sheet P, and the movable blade 52 is placed on the front surface side of the label sheet P. Note that, the fixed blade 51 may be placed on the front surface side of the label sheet P and the movable blade 52 may be placed on the rear surface side of the label sheet P, or alternatively, the movable blades may be provided on both sides of the label sheet P. The movable blade 52 freely slides to approach or be separate with respect to the fixed blade 51, and can cut the label sheet P while vertically sandwiching the label sheet P between the movable blade 52 and the fixed blade 51. Note that, second conveyance rollers 65 are placed on the downstream side of the cutter unit 50, for delivering the cut pressure-sensitive adhesive label 10 toward the downstream side while sandwiching the pressure-sensitive adhesive label 10 in the thickness direction.

The pressure-sensitive adhesive force expressing unit 60 includes a platen roller 61 and a thermal head 70 that are arranged to be opposed in the thickness direction of the pressure-sensitive adhesive label 10 (vertical direction of FIG. 1), a motor unit 62 for driving the platen roller 61, and a control unit 90 for controlling those members. Note that, the control unit 90 may control the overall printer 1 including the printing unit 30, or the printing unit 30 and other members may be controlled by another control unit than the control unit 90.

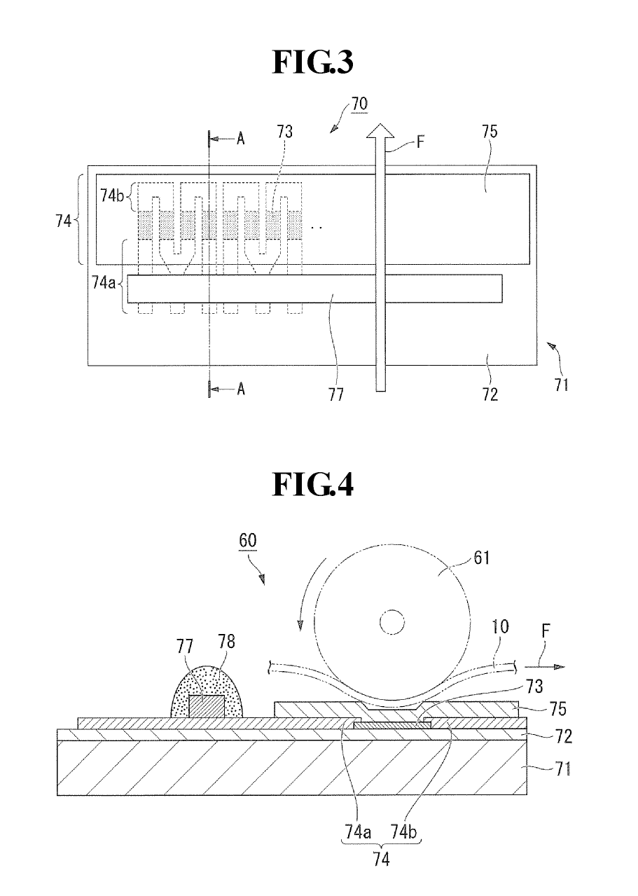

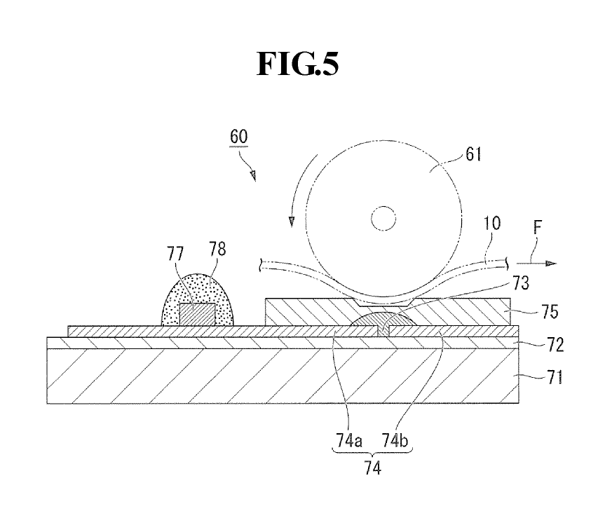

FIG. 3 is an exemplary plan view of the thermal head 70 when viewed from the pressure-sensitive adhesive label 10 side. The thermal head 70 includes, in order from the bottom (from the further side when viewed from the pressure-sensitive adhesive label 10 side), a ceramic substrate 71 serving as a heat radiation substrate and a glaze layer (heat storage layer) 72 laminated over the entire surface of the ceramic substrate 71. On the glaze layer 72, there are provided a plurality of heat generating elements 73 arranged in line along a direction substantially orthogonal to the conveyance direction F, an electrode portion 74 connected to the heat generating elements 73, a protective layer 75 for protecting the heat generating elements 73 and a part of the electrode portion 74, and an integrated circuit (IC) unit 77 for applying a voltage to the electrode portion 74 to heat the heat generating elements 73. The IC unit 77 is protected by a sealing portion 78 made of a resin or the like (see FIG. 4).

The glaze layer 72 is formed, for example, by firing printed glass paste at a predetermined temperature (for example, 1,300° C. to 1,500° C.). The heat generating element 73 is formed on the glaze layer 72, for example, by laminating a heating resistor made of Ta—SiO₂ or the like by sputtering or the like and thereafter patterning the heating resistor by photolithography or the like. The protective layer 75 is a layer for preventing oxidation and abrasion of the heat generating elements 73 and the electrode portion 74, and is formed of a hard metal oxide such as Si—O—N or Si—Al—O—N.

FIG. 4 is an exemplary cross-sectional view taken along the line A-A of FIG. 3. The ceramic substrate 71 is supported by a head support substrate (not shown), and is biased toward the platen roller 61 side by a coil spring (not shown) or the like to be brought into pressure contact with an outer peripheral surface of the platen roller 61. In this manner, the pressure-sensitive adhesive label 10 is in the state of being sandwiched between the thermal head 70 and the platen roller 61 to be pressed against the thermal head 70. The platen roller 61 is placed on the front surface side of the label sheet P so as to be rotatable by the motor unit 62. The pressure-sensitive adhesive force expressing unit 60 drives the motor unit 62 to rotate the platen roller 61 in a state in which the pressure-sensitive adhesive label 10 is sandwiched between the platen roller 61 and the thermal head 70, thereby being capable of conveying the pressure-sensitive adhesive label 10 to the downstream side.

With this configuration, the pressure-sensitive adhesive force expressing unit 60 rotates the platen roller 61 to convey the pressure-sensitive adhesive label 10 to the downstream side, and the IC unit 77 heats the heat generating elements 73 individually to form the bores 15 at desired positions of the function layer 14 of the pressure-sensitive adhesive label 10. When the bores 15 are formed, the pressure-sensitive adhesive layer 13 of the pressure-sensitive adhesive label 10 is exposed through the bores 15, and hence pressure-sensitive adhesive force is expressed on the surface of the pressure-sensitive adhesive label on the function layer 14 side. Heating control of the heat generating elements 73 is described later.

Note that, the connection shape between the heat generating element 73 and the electrode portion 74 is not limited to the shape illustrated in FIG. 4 (thin film type), but may be such a shape illustrated in FIG. 5 (thick film type). FIG. 5 is a diagram illustrating another example of the connection shape between the heat generating element 73 and the electrode portion 74.

Now, the operation of the printer 1 is described below. First, the printer 1 prepares to operate. Specifically, as illustrated in FIG. 1, after the roll paper R is set in the roll paper receiving portion 20, the label sheet P is pulled out of the roll paper receiving portion 20, and the downstream end of the label sheet P is inserted between the first conveyance rollers 35.

Next, the printer 1 is connected to an external input device (host computer) (not shown), and the external input device outputs label information to the printer 1 together with a label issuing instruction. Examples of the label information include size information of the pressure-sensitive adhesive label 10, printing data, and formation pattern data of the bores 15 for expressing pressure-sensitive adhesive force. When the printer 1 receives the label issuing instruction and the label information, a drive source (not shown) is driven so that power of the drive source is transmitted to various kinds of rollers to rotate the various kinds of rollers. In this manner, the label sheet P inserted between the first conveyance rollers 35 is delivered toward the downstream side to be supplied to the printing unit 30.

The label sheet P supplied to the printing unit 30 is delivered toward the downstream side between the printing platen roller 31 and the printing thermal head 32. At this time, the printing thermal head 32 is driven to perform a printing operation corresponding to the label information. In this manner, when the label sheet P passes between the printing platen roller 31 and the printing thermal head 32, a barcode or characters are sequentially printed on the printable layer 12 of the label sheet P (printing step).

Subsequently, the label sheet P having passed through the printing unit 30 is supplied to the cutter unit 50 (cutting step). The label sheet P supplied to the cutter unit 50 is delivered toward the downstream side between the fixed blade 51 and the movable blade 52. Then, when the label sheet P passes between the fixed blade 51 and the movable blade 52 by a desired length, the cutter unit 50 operates so that the movable blade 52 slides and moves toward the fixed blade 51. In this manner, the label sheet P can be cut while being sandwiched between the movable blade 52 and the fixed blade 51, and hence the pressure-sensitive adhesive label 10 adjusted to have a desired length can be obtained. Note that, the method of detecting that the label sheet P has passed by a desired length is, for example, a method involving using an optical sensor or a micro switch (not shown) or a method involving detection based on label length dimensions indicated by the label information and a calculated value of a label feed amount of the label sheet P.

The pressure-sensitive adhesive label 10 having passed through the cutter unit 50 is delivered toward the downstream side by the second conveyance rollers 65 to be supplied to the pressure-sensitive adhesive force expressing unit 60 (pressure-sensitive adhesive force expressing step). The pressure-sensitive adhesive label 10 having the bores 15 formed therein by the pressure-sensitive adhesive force expressing unit 60 is discharged from the printer 1 by third conveyance rollers 66.

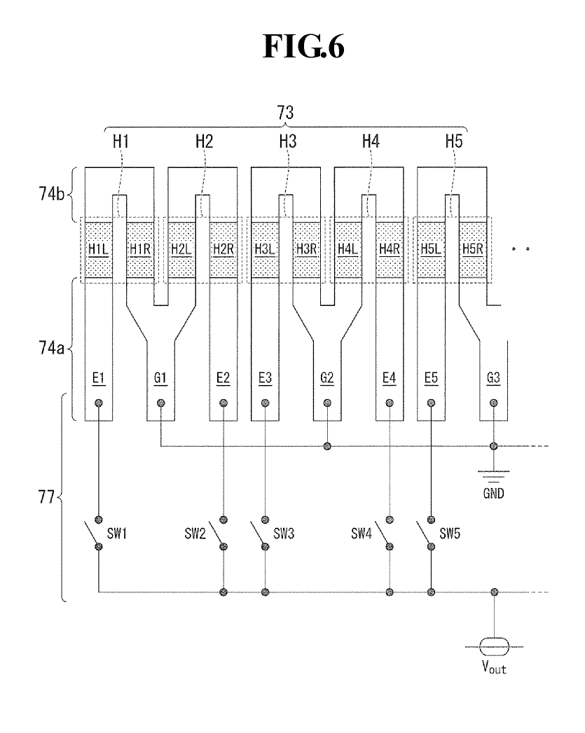

Now, a description is given of the control of the heat generating elements 73 performed by the control unit 90 and the IC unit 77. FIG. 6 is a diagram exemplifying a connection relationship between the plurality of heat generating elements 73 and the electrode portion 74. The heat generating elements 73 are arranged in line at predetermined equal pitches along a longitudinal direction of the ceramic substrate 71. Note that, each heat generating element 73 has a substantially rectangular shape with a long side/short side ratio of about 2:1 to about 3:1 in plan view.

In the plurality of heat generating elements 73 in this embodiment, adjacent two heat generating elements 73 are treated as a set, and the two heat generating elements 73 are designed to generate heat at the same timing. A set of two heat generating elements 73 that generate heat at the same timing is hereinafter referred to as “heat generating unit H1, H2, H3, H4, H5, . . . ”. For example, the heat generating unit H1 includes a left heat generating element H1L and a right heat generating element H1R. The same holds true for the heat generating units H2, H3, H4, H5, . . . . Further, in an electrode portion 74a, parts to be applied with a voltage from a power supply voltage Vₒᵤₜ via switches SW1, SW2, SW3, SW4, SW5, . . . are referred to as “individual electrodes E1, E2, E3, E4, E5, . . . ”, and in the electrode portion 74a, parts to be connected to a ground terminal GND are referred to as “common electrodes G1, G2, G3, . . . ”. The switch SW1 corresponds to the heat generating unit H1, the switch SW2 corresponds to the heat generating unit H2, the switch SW3 corresponds to the heat generating unit H3, the switch SW4 corresponds to the heat generating unit H4, and the switch SW5 corresponds to the heat generating unit H5. The same holds true for the other switches.

The left heat generating element H1L of the heat generating unit H1 is connected to the individual electrode E1 that is connected to the power supply voltage Vₒᵤₜ via the switch SW1, and the right heat generating element H1R of the heat generating unit H1 is connected to the common electrode G1 that is connected to the ground terminal GND. The left heat generating element H2L of the heat generating unit H2 is connected to the common electrode G1 that is connected to the ground terminal GND, and the right heat generating element H2R of the heat generating unit H2 is connected to the individual electrode E2 that is connected to the power supply voltage Vₒᵤₜ via the switch SW2. The left heat generating element H3L of the heat generating unit H3 is connected to the individual electrode E3 that is connected to the power supply voltage Vₒᵤₜ via the switch SW3, and the right heat generating element H3R of the heat generating unit H3 is connected to the common electrode G2 that is connected to the ground terminal GND. The left heat generating element H4L of the heat generating unit H4 is connected to the common electrode G2 that is connected to the ground terminal GND, and the right heat generating element H4R of the heat generating unit H4 is connected to the individual electrode E4 that is connected to the power supply voltage Vₒᵤₜ via the switch SW4. The left heat generating element H5L of the heat generating unit H5 is connected to the individual electrode E5 that is connected to the power supply voltage Vₒᵤₜ via the switch SW5, and the right heat generating element H5R of the heat generating unit H5 is connected to the common electrode G3 that is connected to the ground terminal GND. The configurations are repeated for the other heat generating units so that the plurality of heat generating elements 73 and the electrode portion 74 are connected to the IC unit 77.

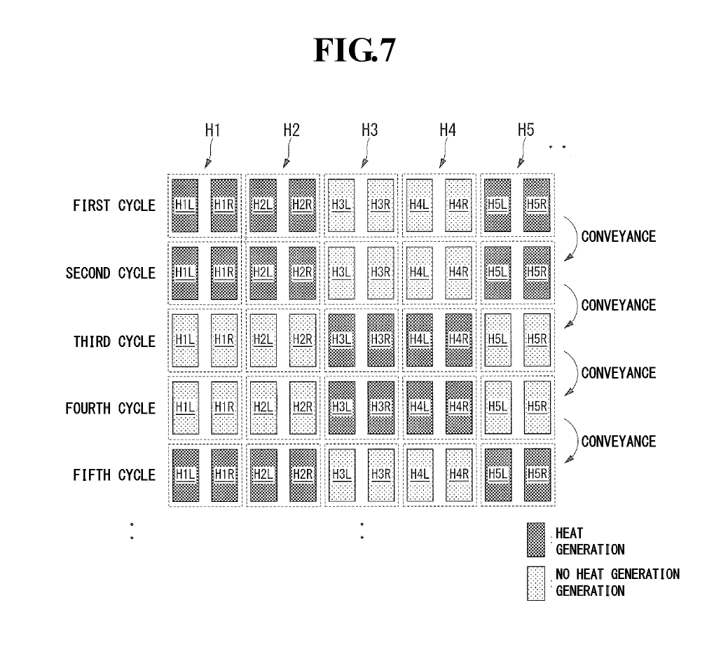

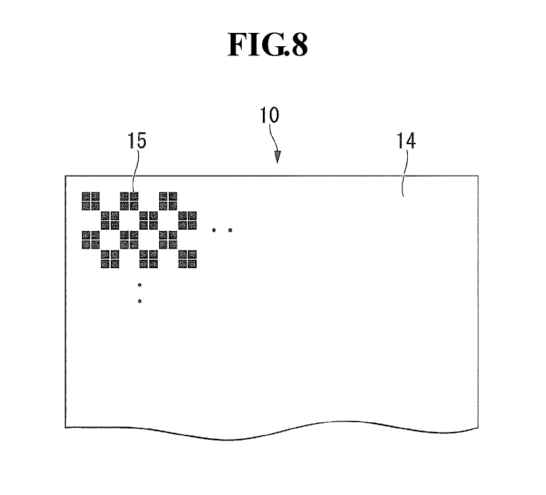

The heat generating units H1, H2, H3, H4, H15, . . . are controlled so that, for example, in a period during which a heat generating period of one cycle of forming the bores 15 for one line arrives periodically, the heat generating units may repeatedly generate heat in a manner that the heat generating units H1, H2, H5, H6, H9, H10, . . . generate heat in the first cycle and the second cycle, the heat generating units H3, H4, H7, H8, H11, H12, . . . generate heat in the third cycle and the fourth cycle, the heat generating units H1, H2, H5, H6, H9, H10, . . . generate heat in the fifth cycle and the sixth cycle, and the heat generating units H3, H4, H7, H8, H11, H12, . . . generate heat in the seventh cycle and the eighth cycle. When the heat generating period of one cycle is finished, the platen roller 61 rotates to convey the pressure-sensitive adhesive label 10 toward the downstream side by, for example, about the length of each heat generating element 73 in the longitudinal direction, and then the next heat generating cycle arrives (heating may be performed while the pressure-sensitive adhesive label 10 is continuously conveyed at a constant pace). As a result, in the function layer 14 of the pressure-sensitive adhesive label 10, a plurality of bores 15 having a shape close to a checkered pattern of (ideally) 2 dots by 2 dots are formed. The “dot” means the bores 15 formed by one heat generating unit. FIG. 7 is a diagram schematically illustrating how each heat generating unit generates heat in each cycle. FIG. 8 is a diagram schematically illustrating how the plurality of bores 15 having the shape close to the checkered pattern are formed in the pressure-sensitive adhesive label 10 as a result of the heat generation of each heat generating unit.

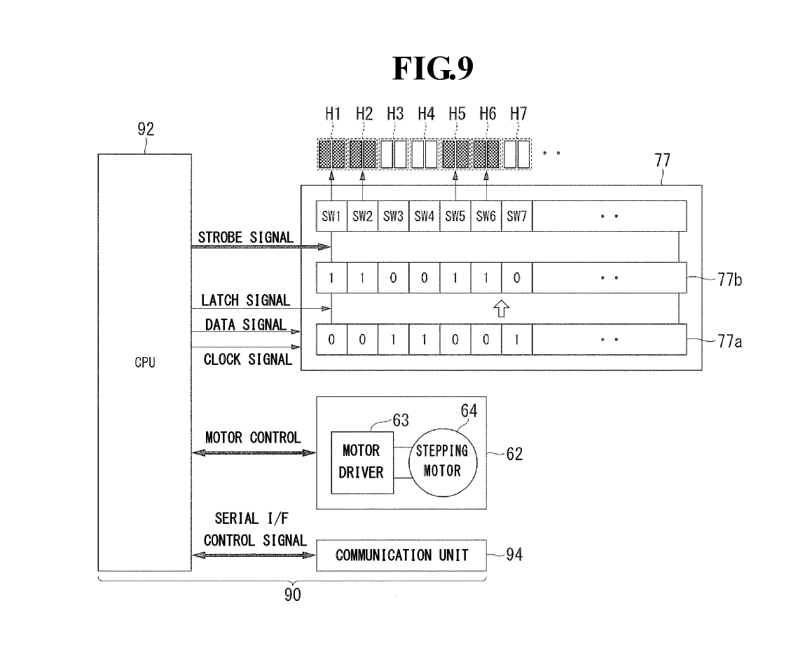

FIG. 9 is an exemplary configuration diagram mainly illustrating the control unit 90 and the IC unit 77. The IC unit 77 includes a shift register 77a and a latch register 77b in addition to the above-mentioned switches. Further, the control unit 90 includes a central processing unit (CPU) 92 and a communication unit 94.

The CPU 92 transmits a motor control signal to the motor unit 62. The motor unit 62 includes a motor driver 63 and a stepping motor 64. The motor driver 63 drives the stepping motor 64 based on the motor control signal to rotate the platen roller 61. The CPU 92 transmits a serial I/F control signal to the communication unit 94. The communication unit 94 includes a serial port and a serial communication driver. The communication unit 94 transfers a printing command or the like supplied from the external input device to the CPU 92, and transmits the state of the printer 1 side to the external input device.

The CPU 92 transmits, to the IC unit 77, a clock signal, a data signal for instructing which one of the heat generating units is to be controlled to generate heat, a latch signal for instructing to copy data from the shift register 77a to the latch register 77b, a strobe signal for instructing to turn on or off the switches based on the value stored in the latch register 77b, and other signals. The data signal is transmitted in the form of “11001100 . . . ” or “00110011 . . . ”. The bit string of the data signal is stored in the shift register 77a one bit by one bit in order. When the latch signal (pulse signal) is input to the shift register 77a, the bit string stored in the shift register 77a is transferred (copied) to the latch register 77b. Then, when the strobe signal is turned on, the respective switches (SW1, SW2, . . . ) corresponding to “1” of the latch register 77b are turned on, and the heat generating units corresponding to the switches are energized so that the heat generating units generate heat.

With the configuration and control as described above, the control illustrated in FIGS. 7 and 8 is realized to form the plurality of bores 15 having the shape close to the checkered pattern in the pressure-sensitive adhesive label 10.

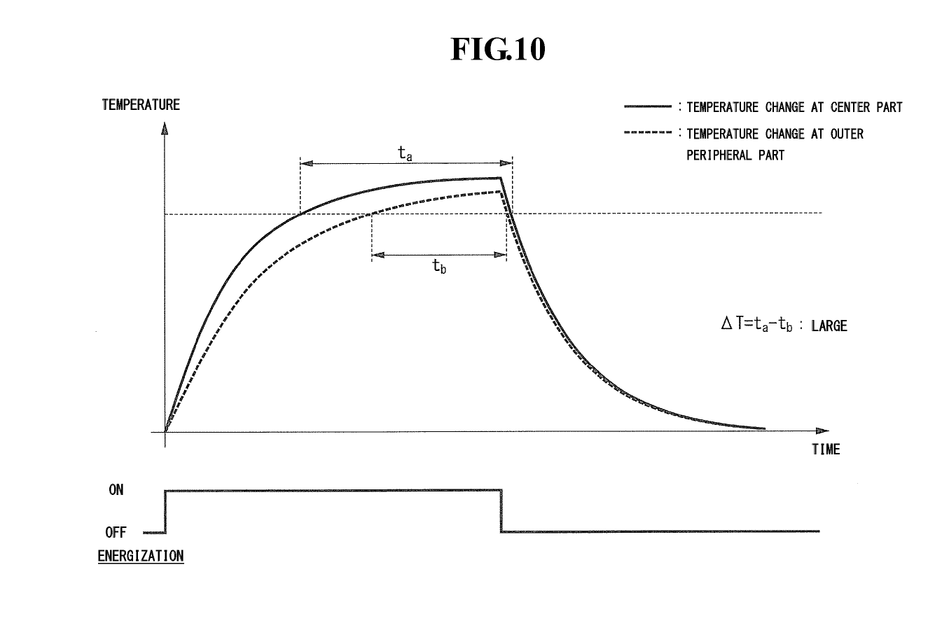

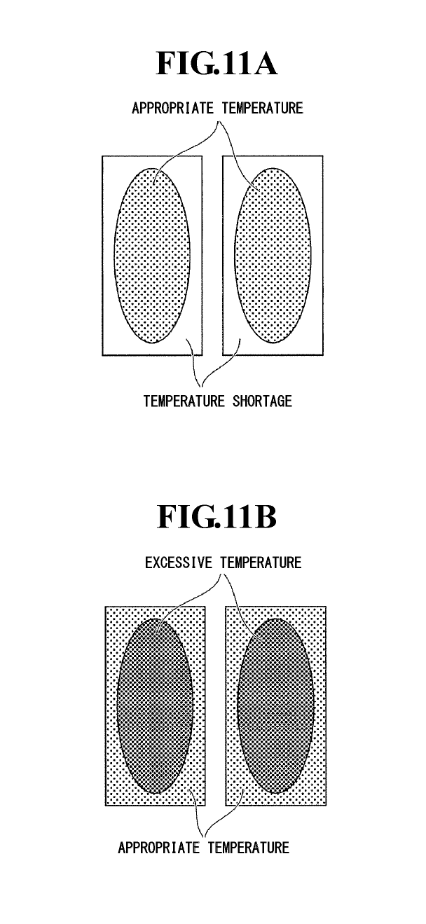

By the way, when the heat generating element 73 generates heat, the rise in temperature is not uniform in the heat generating element 73, but has such characteristics that the temperature rises faster at the center part when viewed from the pressure-sensitive adhesive label 10 side and the temperature rises slower at the outer peripheral part. FIG. 10 is a graph exemplifying a relationship between an energization period of the heat generating element 73 and the rise in temperature at the center part and the outer peripheral part of the heat generating element 73 in a commonly used device. In FIG. 10, the solid line represents a temperature rise curve at the center part of the heat generating element 73, and the broken line represents a temperature rise curve at the outer peripheral part of the heat generating element 73. In FIG. 10, HA represents a bore temperature necessary for forming the bore 15 in the pressure-sensitive adhesive label 10 (melting temperature of the function layer 14). As described above, the bore temperature is about 170° C. when PP is used for the function layer 14, and is about 260° C. when PET is used therefor. Because of the characteristics described above, a difference ΔT between a time tₐ in which the center part of the heat generating element 73 has the bore temperature HA or higher and a time t_{b} in which the outer peripheral part of the heat generating element 73 has the bore temperature HA or higher becomes larger, with the result that a desired bore 15 may not be formed. The temperature of the heat generating element 73 becomes higher as a longer energization is performed in heat generation of one cycle. FIG. 11A is an exemplary temperature distribution of the heat generating elements 73 when the energization time is set relatively shorter, and FIG. 11B is an exemplary temperature distribution of the heat generating elements 73 when the energization time is set relatively longer.

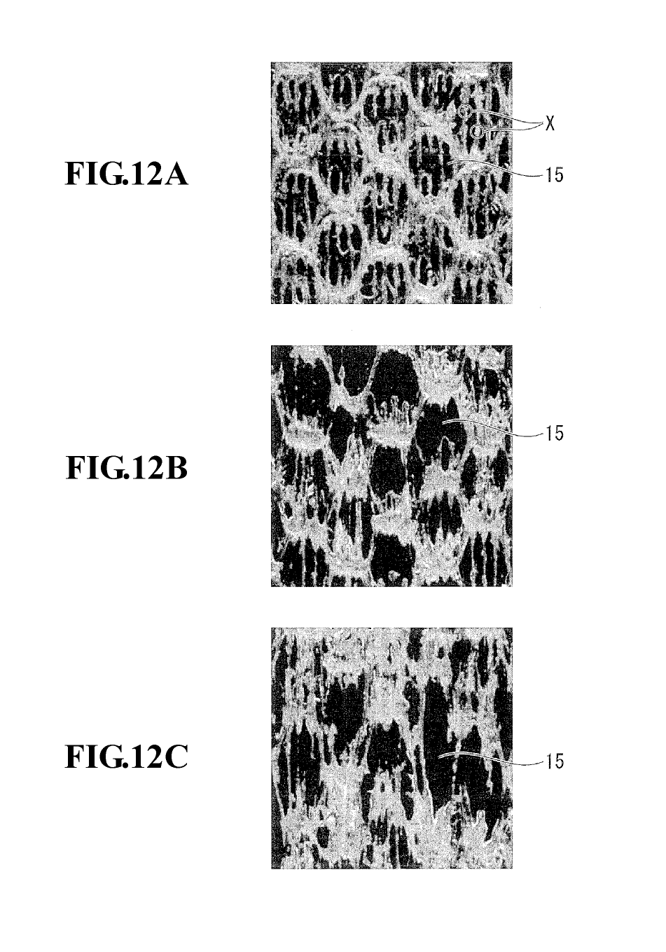

Further, FIGS. 12A to 12C are photographs showing the results of forming the bores 15 in the pressure-sensitive adhesive label 10 while changing the energization time variously. FIG. 12A shows the result when the energization time is the shortest, FIG. 12B shows the result when the energization time is moderate, and FIG. 12C shows the result when the energization time is the longest. As shown in FIG. 12A, when the energization time is short, the function layer 14 does not melt sufficiently, for example, in a region between the set of heat generating elements 73 generating heat, and a linear unmelted residue X may appear so that sufficient pressure-sensitive adhesive force cannot be exerted. If the energization time is increased to prevent this problem, as shown in FIGS. 12B and 12C, the bores 15 lose shape, and the melted function layer 14 may agglutinate to generate undesirable unevenness on a pressure-sensitive adhesive surface.

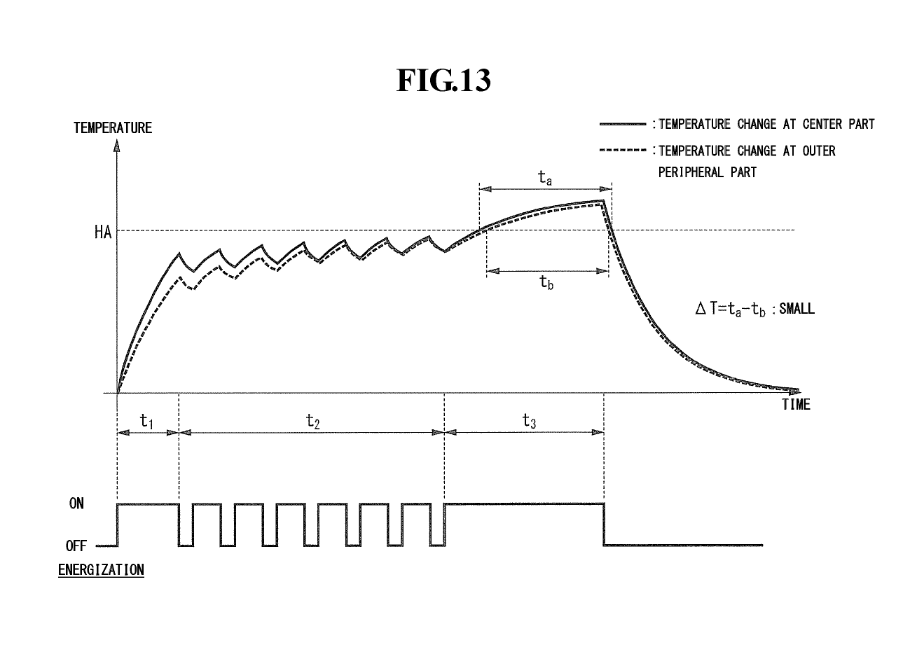

To address this problem, in the pressure-sensitive adhesive force expressing unit 60 according to this embodiment, a pulse chopping period of performing intermittent energization is provided in the energization control of the heat generating elements 73, to thereby stabilize the shape of the bores 15. FIG. 13 is a graph exemplifying a relationship between the energization period of the heat generating element 73 and the rise in temperature at the center part and the outer peripheral part of the heat generating element 73 in the case where the energization control of the heat generating element 73 is performed by the CPU 92 and the IC unit 77 according to this embodiment. As shown in FIG. 13, the heat generating element 73 is energized in the order of a first period t₁ for continuous energization, a second period t₂ (pulse chopping period) for intermittent energization, and a third period t₃ for continuous energization. Note that, such energization control is realized by, for example, ON/OFF control of a strobe signal.

In the first period t₁, the temperature of the heat generating element 73 rises to quickly approach the bore temperature HA. The first period t₁ is set to such a time that the temperature difference between the center part and the outer peripheral part of the heat generating element 73 does not become too large. Note that, the first period t₁ may be omitted (pulse chopping may be performed from the beginning).

In the second period t₂, the temperature of the heat generating element 73 is maintained at a temperature slightly lower than the bore temperature HA. A duty factor in the second period t₂ is set in advance so that the temperature of the heat generating element 73 may not exceed the bore temperature HA. In this second period t₂, the temperature at the outer peripheral part of the heat generating element 73 gradually approaches the temperature at the center part thereof, and hence the temperature difference is resolved to some extent.

Then, in the third period t₃, the temperature of the heat generating element 73 is controlled so that the temperatures at both the center part and the outer peripheral part may exceed the bore temperature HA. Note that, the third period t₃ may be an intermittent energization period in which the duty factor is larger than that in the second period t₂, for example.

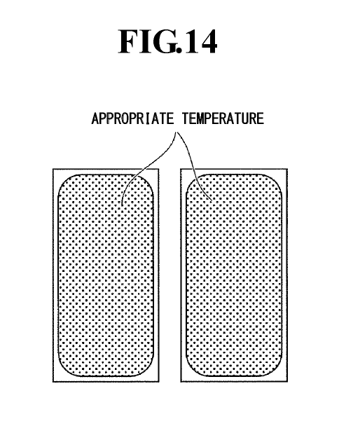

With such control, at the time point when the temperature of the heat generating element 73 exceeds the bore temperature HA, the temperature distribution of the heat generating element 73 becomes sufficiently uniform. FIG. 14 is an exemplary uniformized temperature distribution of the heat generating element 73. As a result, the difference ΔT between the time tₐ in which the center part of the heat generating element 73 has the bore temperature or higher and the time t_{b} in which the outer peripheral part of the heat generating element 73 has the bore temperature HA or higher becomes sufficiently smaller. Consequently, the bore 15 having a preferred shape can be formed stably.

The CPU 92 executes a program stored in a program memory (not shown) to set the first period t₁, the second period t₂, the third period t₃, and the number of times of energization in the second period t₂ and perform the ON/OFF control of the strobe signal.

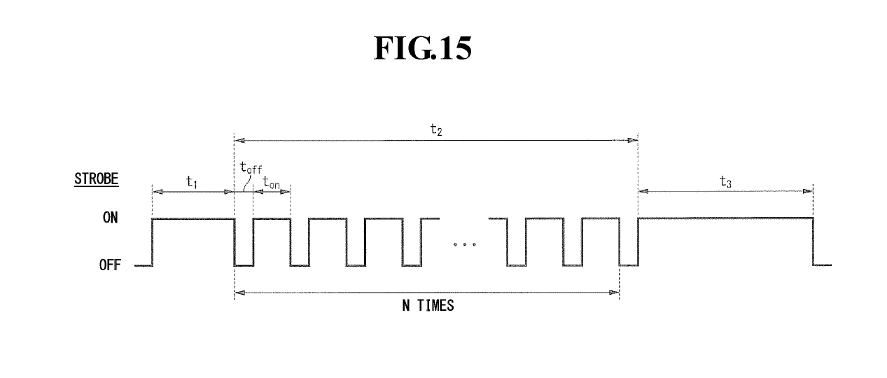

FIG. 15 is an explanatory diagram for describing the definition of the periods to be set by the CPU 92. As shown in FIG. 15, in the second period t₂, intermittent energization (pulse chopping) is performed N times plus surplus in total. In the following, a time t₁ is a time scheduled for energization in the first period (scheduled value), and a time t₃ is a time scheduled for energization in the third period. Further, a time during which no energization is performed in the second period (strobe off) is set as t_{off} in advance, and a time during which energization is performed (strobe on) is set as tₒₙ in advance. Using those definitions, the processing of the CPU 92 is described below.

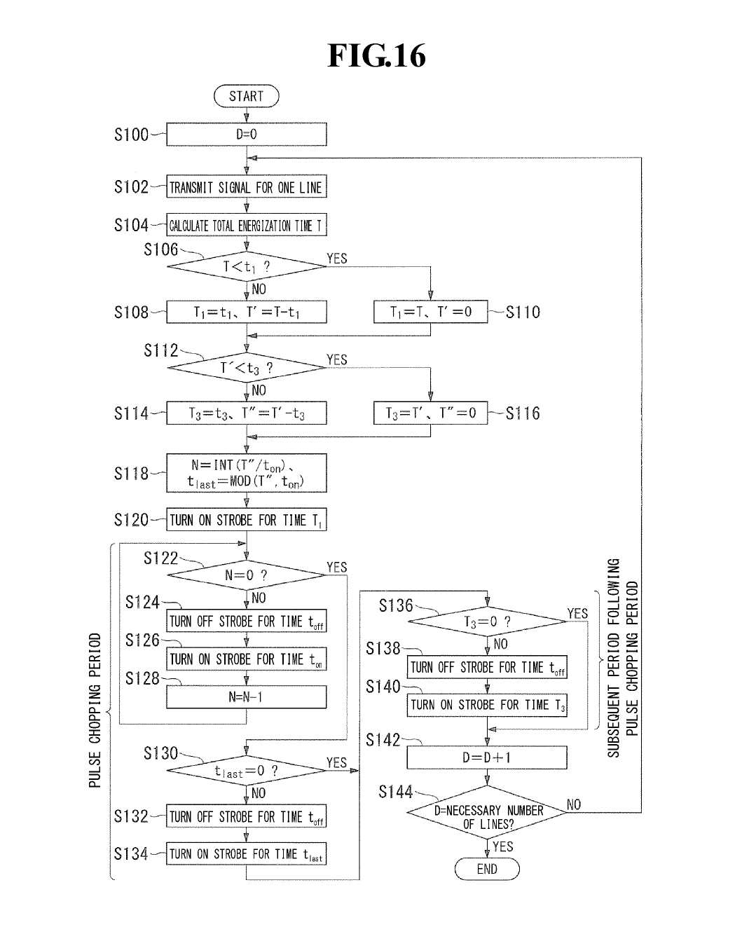

FIG. 16 is an exemplary flowchart illustrating the flow of processing executed by the CPU 92. First, the CPU 92 sets an initial value of a line number counter D to zero (Step S100).

Next, the CPU 92 transmits a data signal for one line to the IC unit 77, and transmits a latch signal thereafter (Step S102). Next, the CPU 92 calculates a total energization time T for one line (Step S104). The total energization time T is calculated based on a temperature of the thermal head 70 detected by a temperature sensor (not shown), resistance values of the heat generating element 73 and the electrode portion 74, the power supply voltage Vₒᵤₜ, reference energy, and the like. Note that, the data signal can be transmitted at an arbitrary timing after the latch signal is transmitted, and is not limited to the timing described in this flowchart.

Next, the CPU 92 determines whether or not the total energization time T is less than the time t₁ (Step S106). When the total energization time T is equal to or more than the time t₁, the CPU 92 sets the time t₁ as the first period T₁, and calculates a remaining time T′ obtained by subtracting the time t₁ from the total energization time T (Step S108). The first period T₁ is a time for actually performing energization as the first period. On the other hand, when the total energization time T is less than the time t₁, the CPU 92 sets the total energization time T as the time T₁, and sets the remaining time T′ to zero (Step S110). In this case, the energization in the second period and the third period is not performed, but only the energization in the first period is performed to finish the heat generation in the line concerned.

Next, the CPU 92 determines whether or not the remaining time T′ is less than the time t₃ (Step S112). When the remaining time T′ is equal to or more than the time t₃, the CPU 92 sets the time t₃ as the third period T₃, and calculates a remaining time T″ obtained by subtracting the time t₃ from the remaining time T′ (Step S114). The third period T₃ is a time for actually performing energization as the third period. On the other hand, when the remaining time T′ is less than the time t₃, the CPU 92 sets the remaining time T′ as the time T₃, and sets the remaining time T″ to zero (Step S116). In this case, the energization in the second period is not performed, but only the energization in the first period and the third period is performed to finish the heat generation in the line concerned.

Next, the CPU 92 calculates an initial value of a remaining count N of performing intermittent energization in the second period, and also calculates its surplus time tₗₐₛₜ (Step S118). The count N is calculated by dividing the remaining time T″ by tₒₙ and truncating the remainder. The surplus time tₗₐₛₜ is calculated as the remainder of the division of the remaining time T″ by tₒₙ.

After finishing the calculation described above, the CPU 92 turns on the strobe signal for a time corresponding to the first period T₁ (Step S120).

Next, the CPU 92 determines whether or not the remaining count N is zero (Step S122). When the remaining count is not zero, the CPU 92 turns off the strobe signal for a time corresponding to t_{off} (Step S124), then turns on the strobe signal for the time corresponding to tₒₙ (Step S126), and decrements the remaining count N by 1 (Step S128). Then, the flow returns to Step S122.

When the remaining count N becomes zero, the CPU 92 determines whether or not the surplus time tₗₐₛₜ is zero (Step S130). When the surplus time tₗₐₛₜ is not zero, the CPU 92 turns off the strobe signal for the time corresponding to t_{off} (Step S132), and then turns on the strobe signal for a time corresponding to tₗₐₛₜ (Step S134).

Next, the CPU 92 determines whether or not the third period T₃ is zero (Step S136). When the third period T₃ is not zero, the CPU 92 turns off the strobe signal for the time corresponding to t_{off} (Step S138), and then turns on the strobe signal for a time corresponding to the third period T₃ (Step S140).

After finishing those pieces of processing, the CPU 92 increments the line number counter D by 1 (Step S142), and determines whether or not the line number counter D has reached a necessary number of lines (Step S144). When the line number counter D has not reached a necessary number of lines, the CPU 92 transmits a data signal for the next one line and other signals to the IC unit 77 (Step S102), and performs processing after Step S104.

When the line number counter D has reached a necessary number of lines, the CPU 92 finishes the processing of this flowchart. In this manner, the creation of one pressure-sensitive adhesive label 10 is completed.

According to the pressure-sensitive adhesive force expressing unit 60 in this embodiment described above, the pulse chopping period of performing intermittent energization is provided in the energization control of the heat generating element 73, and hence the bore 15 having a preferred shape can be formed stably.

More specifically, according to the pressure-sensitive adhesive force expressing unit 60 in this embodiment, in the second period as the intermittent energization period, the temperature of the heat generating element 73 is maintained at a temperature slightly lower than the bore temperature HA, and after the temperature at the outer peripheral part of the heat generating element 73 gradually approaches the temperature at the center part in this period, the second period shifts to the third period in which the temperature of the heat generating element 73 is controlled to exceed the bore temperature HA. Thus, at the time when the temperature of the heat generating element 73 exceeds the bore temperature HA, it can be expected that the temperature of the heat generating element 73 becomes sufficiently uniform. Consequently, the pressure-sensitive adhesive force expressing unit 60 according to this embodiment can stably form the bore 15 having a preferred shape.

Further, according to the pressure-sensitive adhesive label issuing device 40 and the printer 1 using the pressure-sensitive adhesive force expressing unit 60 in this embodiment, the pressure-sensitive adhesive label 10 in which the bores 15 having preferred shapes are stably formed can be created.

While the embodiments of the present invention have been described above, the present invention is not limited to the embodiments, and various kinds of modifications and replacements may be added within the range not departing from the gist of the present invention.

What is claimed is:

1. A pressure-sensitive adhesive force expressing unit that is configured to heat a pressure-sensitive adhesive label to express pressure-sensitive adhesive force thereof, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer,
the pressure-sensitive adhesive force expressing unit including:
a conveyance unit for conveying the pressure-sensitive adhesive label in a predetermined direction;
a thermal head including a plurality of heat generating elements arranged along a direction substantially orthogonal to the predetermined direction, the thermal head being configured to heat the pressure-sensitive adhesive label from the pressure-sensitive adhesive layer side to form a bore in the non-pressure-sensitive-adhesive function layer and expose the pressure-sensitive adhesive layer; and
a control unit for energizing the plurality of heat generating elements individually to control the plurality of heat generating elements to generate heat, the control unit being configured to control the plurality of heat generating elements to generate heat by providing an intermittent energization period of intermittently energizing the plurality of heat generating elements in a heat generating period of one cycle of forming bores for one row in the non-pressure-sensitive-adhesive function layer.

2. A pressure-sensitive adhesive force expressing unit according to claim 1, wherein
the control unit provides, in the heat generating period of one cycle, after the intermittent energization period, a subsequent energization period in which a temperature reached by the plurality of heat generating elements is higher than in the intermittent energization period.

3. A pressure-sensitive adhesive force expressing unit according to claim 2, wherein
the control unit energizes the plurality of heat generating elements continuously in the subsequent energization period.

4. A pressure-sensitive adhesive force expressing unit according to claim 2, wherein
the control unit maintains the plurality of heat generating elements at a temperature lower than a melting temperature of the non-pressure-sensitive-adhesive function layer in the intermittent energization period, and guides the plurality of heat generating elements to have a temperature higher than the melting temperature of the non-pressure-sensitive-adhesive function layer in the subsequent energization period.

5. A pressure-sensitive adhesive label issuing device including:
the pressure-sensitive adhesive force expressing unit according to claim 1; and
a cutter unit for cutting the pressure-sensitive adhesive label to a desired length.

6. A printer including:
the pressure-sensitive adhesive label issuing device according to claim 5; and
a printing unit for printing on the printable layer, which is placed on an upstream side of the pressure-sensitive adhesive force expressing unit in the predetermined direction.

7. A pressure-sensitive adhesive force expressing unit according to claim 3, wherein
the control unit maintains the plurality of heat generating elements at a temperature lower than a melting temperature of the non-pressure-sensitive-adhesive function layer in the intermittent energization period, and guides the plurality of heat generating elements to have a temperature higher than the melting temperature of the non-pressure-sensitive-adhesive function layer in the subsequent energization period.

8. A pressure-sensitive adhesive label issuing device including:
the pressure-sensitive adhesive force expressing unit according to claim 7; and
a cutter unit for cutting the pressure-sensitive adhesive label to a desired length.

9. A printer including:
the pressure-sensitive adhesive label issuing device according to claim 8; and
a printing unit for printing on the printable layer, which is placed on an upstream side of the pressure-sensitive adhesive force expressing unit in the predetermined direction.

10. A pressure-sensitive adhesive force expressing method for a computer for controlling a pressure-sensitive adhesive force expressing unit,
the pressure-sensitive adhesive force expressing unit including:
a conveyance unit for conveying a pressure-sensitive adhesive label in a predetermined direction, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer; and
a thermal head including a plurality of heat generating elements arranged along a direction substantially orthogonal to the predetermined direction, the thermal head being configured to heat the pressure-sensitive adhesive label from the pressure-sensitive adhesive layer side to form a bore in the non-pressure-sensitive-adhesive function layer and expose the pressure-sensitive adhesive layer,
the pressure-sensitive adhesive force expressing method including:
setting, by the computer, an intermittent energization period of intermittently energizing the plurality of heat generating elements in a heat generating period of one cycle of forming bores for one row in the non-pressure-sensitive-adhesive function layer; and
intermittently energizing, by the computer, the plurality of heat generating elements in the set intermittent energization period.

11. A pressure-sensitive adhesive force expressing program for causing a computer for controlling a pressure-sensitive adhesive force expressing unit,
the pressure-sensitive adhesive force expressing unit including:
a conveyance unit for conveying a pressure-sensitive adhesive label in a predetermined direction, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer; and
a thermal head including a plurality of heat generating elements arranged along a direction substantially orthogonal to the predetermined direction, the thermal head being configured to heat the pressure-sensitive adhesive label from the pressure-sensitive adhesive layer side to form a bore in the non-pressure-sensitive-adhesive function layer and expose the pressure-sensitive adhesive layer,
to perform processing of:
setting an intermittent energization period of intermittently energizing the plurality of heat generating elements in a heat generating period of one cycle of forming bores for one row in the non-pressure-sensitive-adhesive function layer; and
intermittently energizing the plurality of heat generating elements in the set intermittent energization period.
